(19) United States
(12) Patent Application Publication
(10) Pub. No.: US 2026/0128230 A1
(43) Pub. Date: May 7, 2026

(54) ELECTRONIC COMPONENT AND COMPOSITE ELECTRONIC COMPONENT

(71) Applicant: Murata Manufacturing Co., Ltd., Nagaokakyo-shi (JP)

(72) Inventors: Shunsuke MIWA, Nagaokakyo-shi (JP); Kenichi ITO, Nagaokakyo-shi (JP); Shigeaki HASHIMOTO, Nagaokakyo-shi (JP)

(21) Appl. No.: 19/440,990

(22) Filed: Jan. 6, 2026

Related U.S. Application Data
(63) Continuation of application No. PCT/JP2024/019744, filed on May 29, 2024.

(30) Foreign Application Priority Data
Aug. 9, 2023 (JP) 2023-130123
Dec. 6, 2023 (JP) 2023-206482

(51) Int. Cl. H01G 4/30; H01C 1/142; H01F 17/00; H01G 4/232

(52) U.S. Cl. CPC H01G 4/30; H01C 1/142; H01F 17/0013; H01G 4/232

(57) ABSTRACT

An electronic component includes a first outer electrode, a base, and a second outer electrode, which are sequentially arranged in a first direction. The first outer electrode includes a first outer electrode main body arranged in a second direction with respect to the second outer electrode over the base and a first outer electrode extension that extends in the first direction from an edge portion of the first outer electrode main body. The second outer electrode includes a second outer electrode main body arranged in the first direction with respect to the first outer electrode over the base and a second outer electrode extension that extends in the second direction from an edge portion of the second outer electrode main body. Portions of the first and second outer electrode extensions opposed to each other in an orthogonal direction are separated by an insulating layer.

### CROSS REFERENCE TO RELATED APPLICATIONS

This application claims the benefit of priority to Japanese Patent Application No. 2023-206482 filed on Dec. 6, 2023 and Japanese Patent Application No. 2023-130123 filed on Aug. 9, 2023, and is a Continuation Application of PCT Application No. PCT/JP2024/019744 filed on May 29, 2024. The entire contents of each application are hereby incorporated herein by reference.

### BACKGROUND OF THE INVENTION

### 1. Field of the Invention

The present disclosure relates to electronic components and composite electronic components.

### 2. Description of the Related Art

An alternating-current coupling circuit described in Japanese Unexamined Patent Application Publication No. 2004-241924 includes a chip capacitor and a die cap that are connected in parallel to each other, as an electronic component removing a direct-current electric component.

### SUMMARY OF THE INVENTION

In order to ensure high capacitance with small volume, a high-permittivity material is selected as the dielectric of a capacitor. The high-permittivity material generally does not have excellent high-frequency characteristics to cause loss of a high-frequency signal. Accordingly, development of an electronic component having reduced or prevented loss of the high-frequency signal is required. In addition, the loss of the high-frequency signal is required to be reduced or prevented even when the electronic component is not the capacitor.

Example embodiments of the present invention provide an electronic component having reduced or prevented loss of a high-frequency signal and a composite electronic component including the electronic component.

An electronic component according to an example embodiment of the present disclosure includes a first outer electrode, a base, and a second outer electrode, which are sequentially arranged in a first direction. A direction opposite to the first direction is a second direction. A direction orthogonal to the first direction is an orthogonal direction. The first outer electrode includes a first outer electrode main body that is arranged in the second direction with respect to the second outer electrode over the base and a first outer electrode extension that extends in the first direction from an edge portion of the first outer electrode main body. The second outer electrode includes a second outer electrode main body that is arranged in the first direction with respect to the first outer electrode over the base and a second outer electrode extension that extends in the second direction from an edge portion of the second outer electrode main body. The first outer electrode includes a first outer electrode main body that is arranged in the second direction with respect to the second outer electrode over the base and a first outer electrode extension that extends in the first direction from an edge portion of the first outer electrode main body. The second outer electrode includes a second outer electrode main body that is arranged in the first direction with respect to the first outer electrode over the base and a second outer electrode extension that extends in the second direction from an edge portion of the second outer electrode main body. A portion of the first outer electrode extension and a portion of the second outer electrode extension compose a pair of opposing portions that are opposed to each other in the orthogonal direction. An insulating layer is provided between the pair of opposing portions.

A composite electronic component according to example embodiment of the present disclosure includes the electronic component, an annular holder portion that extends in a circumferential direction along an outer peripheral surface of the electronic component, and an annular outer conductor portion that extends in the circumferential direction along an outer peripheral surface of the holder portion.

According to the electronic components and the composite electronic components according to example embodiments of the present invention, loss of a high-frequency signal is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an electronic component module of a first example embodiment of the present invention.

FIG. 2 is a diagram when a cross section taken along the line II-II in FIG. 1 is viewed from the direction of arrows.

FIG. 3 is an enlarged view resulting from enlargement of a portion of FIG. 2.

FIG. 4 is a diagram for describing the advantages of an electronic component of the first example embodiment of the present invention.

FIG. 5 is an enlarged view resulting from enlargement of an electronic component of a first modification.

FIG. 6 is a cross-sectional view when an electronic component module of a second example embodiment is cut off along the center line of a coaxial cable.

FIG. 7 is a perspective view of an electronic component of the second example embodiment of the present invention.

FIG. 8 is a cross-sectional view when a cross section taken along the VIII-VIII line in FIG. 7 is viewed from the direction of arrows.

FIG. 9 is a cross-sectional view when a cross section taken along the IX-IX line in FIG. 7 is viewed from the direction of arrows.

FIG. 10 is a cross-sectional view when a cross section taken along the X-X line in FIG. 7 is viewed from the direction of arrows.

FIG. 11 is a diagram for describing the advantages of the electronic component of the second example embodiment of the present invention.

FIG. 12 is a diagram for describing the advantages of an electronic component of a second modification.

FIG. 13 is a cross-sectional view when a cross section taken along the XII-XII line in FIG. 12 is viewed from the direction of arrows.

FIG. 14 is a cross-sectional view illustrating an example in which the electronic component of the first example embodiment is provided in the coaxial cable.

FIG. 15 is a cross-sectional view of an electronic component of a third modification.

FIG. 16 is a cross-sectional view when an electronic component module of a third example embodiment is cut off along the center line of the coaxial cable.

FIG. 17 is a cross-sectional view when a cross section taken along the XVII-XVII line in FIG. 16 is viewed from the direction of arrows.

FIG. 18 is a cross-sectional view when a composite electronic component of a fourth modification is cut off in an orthogonal direction.

FIG. 19 is a cross-sectional view when a composite electronic component of a fifth modification is cut off in the orthogonal direction.

FIG. 20 is a cross-sectional view when an electronic component module of a sixth modification is cut off along the center line of the coaxial cable.

### DETAILED DESCRIPTION OF THE EXAMPLE EMBODIMENTS

Example embodiments of electronic components and composite electronic components of the present disclosure will herein be described in detail with reference to the drawings. The present disclosure is not limited by the example embodiments. The respective example embodiments are only examples and partial replacement or combination of components in different example embodiments is available. Description of matters common to a second example embodiment is omitted and only points different from the second example embodiment are described in a first example embodiment and the subsequent example embodiments. In particular, the same effects and advantages of the same components are not successively described in each example embodiment.

### First Example Embodiment

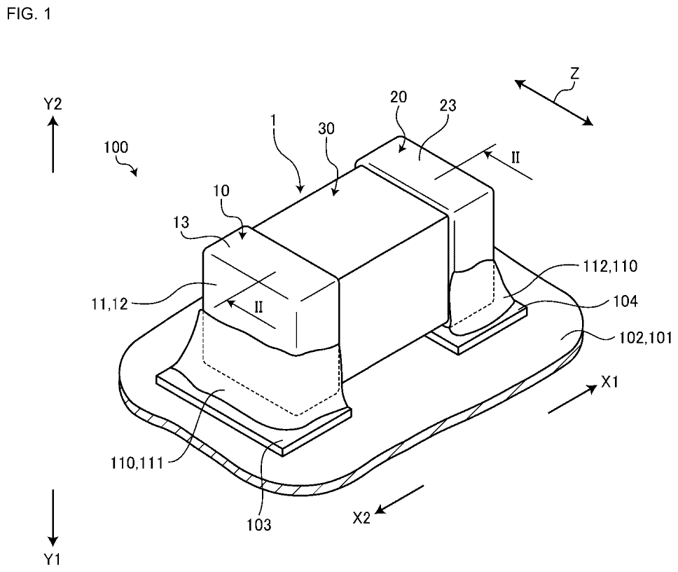

FIG. 1 is a perspective view of an electronic component module of the first example embodiment. As illustrated in FIG. 1, an electronic component module 100 of the first example embodiment includes a substrate 101 including a mounting surface 102, an electronic component 1 on the mounting surface 102, and solder 110 with which the electronic component 1 is fixed to the mounting surface 102.

The substrate 101 is a multilayer wiring board in which wiring layers and insulating layers are alternately laminated. The mounting surface 102 of the substrate 101 includes the insulating layer. A first land electrode 103 and a second land electrode 104 are provided on the mounting surface 102 of the substrate 101. The substrate of example embodiments of the present disclosure is not limited to the multilayer wiring board.

The solder 110 includes first solder 111 with which the first land electrode 103 is joined to the electronic component 1 and second solder 112 with which the second land electrode 104 is joined to the electronic component 1.

The electronic component 1 includes a first outer electrode 10, a base 30, and a second outer electrode 20, which are sequentially arranged in a direction parallel to the mounting surface 102. The direction in which the first outer electrode 10, the base 30, and the second outer electrode 20 are arranged is hereinafter referred to as a length direction. In the length direction, the direction in which the second outer electrode 20 is arranged when viewed from the first outer electrode 10 is referred to as a first direction X1 and the direction opposite to the first direction X1 is referred to as a second direction X2. The direction orthogonal to the length direction (the first direction X1) is referred to as an orthogonal direction. The electronic component 1 has the overall shape of a hexahedron, and all ridges and all corners of the hexahedron are chamfered. Example embodiments of the present disclosure are not limited to the electronic component 1 of the hexahedron in which all the ridges and all the corners of the hexahedron are chamfered and it is sufficient for at least one of the ridges and the corners of the hexahedron to be chamfered. The ridge described above is a portion where two surfaces intersect with each other and the corner described above is a portion where three surfaces intersect with one another.

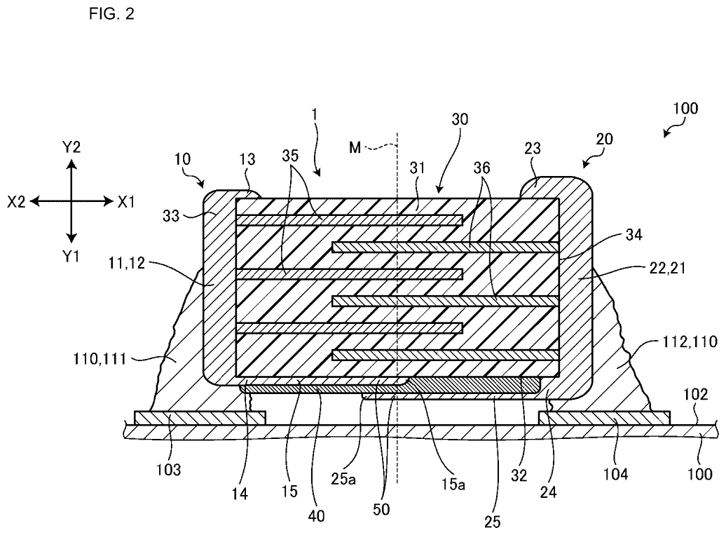

FIG. 2 is a diagram when a cross section taken along the line II-II in FIG. 1 is viewed from the direction of arrows. As illustrated in FIG. 2, the base 30 includes a dielectric body 31, and multiple first inner electrodes 35 and multiple second inner electrodes 36, which are alternately arranged in the dielectric body 31. A broken line M in FIG. 2 is a virtual line passing through the center in the length direction of the base 30.

The dielectric body 31 is made of a ceramic material having, for example, BaTiO₃, CaTiO₃, SrTiO₃, SrZrO₃, CaZrO₃, or the like as a major component. An accessory component, such as a Mn compound, a Fe compound, a Cr compound, a Co compound, a Ni compound, or the like, the content of which is smaller than that of the major component, may be added to the major component. The material of the dielectric body 31 is not limited to the high-permittivity material described above.

The dielectric body 31 preferably has a rectangular or substantially rectangular parallelepiped shape, and includes a first end surface 33 directed to the second direction X2 and a second end surface 34 directed to the first direction X1. A first surface 32 directed to the mounting surface 102 is included in the outer peripheral surface of the dielectric body 31. The first surface 32 is a plane parallel to the mounting surface 102. An insulating layer 40 is provided on the first surface 32. The insulating layer 40 will be described in detail below.

The first inner electrodes 35 and the second inner electrodes 36 preferably are plate shaped and extend in a direction parallel to the mounting surface 102. The direction in which the first inner electrodes 35 and the second inner electrodes 36 are arranged is hereinafter referred to as a laminated direction. In the laminated direction, the direction in which the first surface 32 is arranged when viewed from the first inner electrodes 35 and the second inner electrodes 36 is referred to as a first laminated direction Y1 and the direction opposite to the first laminated direction Y1 is referred to as a second laminated direction Y2. The direction orthogonal to the length direction and the laminated direction is referred to as a width direction Z (refer to FIG. 1).

The first inner electrodes 35 and the second inner electrodes 36 each include, for example, metal such as Ni, Ag, Pd, Au, Cu, Ti, Cr, or the like or alloy or the like containing the above metal as the major component. The first inner electrodes 35 and the second inner electrodes 36 may each include a ceramic material, which is the same as the dielectric ceramic included in the dielectric body 31, as a secondary material.

End portions in the second direction X2 of the first inner electrodes 35 extend to the first end surface 33 of the dielectric body 31 to be joined to the first outer electrode 10. End portions in the first direction X1 of the second inner electrodes 36 extend to the second end surface 34 of the dielectric body 31 to be joined to the second outer electrode 20.

The first inner electrodes 35 and the second inner electrodes 36 are apart from each other in the laminated direction. Accordingly, the dielectric body 31 (dielectric layers) exists between the first inner electrodes 35 and the second inner electrodes 36. Consequently, in the first inner electrodes 35 and the second inner electrodes 36, portions opposed to each other compose counter electrodes. Capacitance is generated by the counter electrodes to cause the electronic component 1 to function as a capacitor.

The first outer electrode 10 and the second outer electrode 20 each include a single metal component. The first outer electrode 10 and the second outer electrode 20 may each include multiple plating layers in the present disclosure and the composition of the first outer electrode 10 and the second outer electrode 20 is not particularly limited.

The first outer electrode 10 includes a first outer electrode main body 11 arranged in the second direction X2 with respect to the base 30 and a first outer electrode extension 15 arranged in the first laminated direction Y1 with respect to the base 30. The first outer electrode main body 11 includes a first opposed wall 12 that is opposed to the first end surface 33 of the dielectric body 31 and an annular first joint 13 that projects from an edge portion of the first opposed wall 12 in the first direction X1. The first opposed wall 12 preferably has a plate shape and extends in the laminated direction and the width direction Z. The first opposed wall 12 preferably has a quadrangular shape when viewed in the length direction. The first inner electrodes 35 are joined to a surface in the first direction X1 of the first opposed wall 12.

The first joint 13 preferably has a rectangular or substantially rectangular frame shape when viewed in the length direction. An end portion in the second direction X2 of the base 30 is fitted into the first joint 13. A portion of the first joint 13 is arranged in the first laminated direction Y1 with respect to the dielectric body 31 to be abut against the first surface 32. A portion that is a portion of the first joint 13 and that abuts against the first surface 32 of the dielectric body 31 is hereinafter referred to as a first mounting surface sidewall 14.

The first outer electrode main body 11 is arranged in the second laminated direction Y2 with respect to the first land electrode 103. The first solder 111 is mainly joined to a face in the second direction X2 of the first opposed wall 12 (refer to FIG. 1). Accordingly, the first outer electrode 10 and the first land electrode 103 are electrically connected to each other.

The first outer electrode extension 15 extends from an edge portion of the first outer electrode main body 11 in the first direction X1. Here, the edge portion of the first outer electrode main body 11 is an edge portion of the first joint 13 (an end portion in the first direction X1 of the first mounting surface sidewall 14 in the present example embodiment). The first outer electrode extension 15 preferably has a plate shape and extends in the length direction and the width direction Z. The first outer electrode extension 15 extends along the first surface 32 to be abut against the first surface 32. An end portion 15a in the first direction X1 of the first outer electrode extension 15 is located on the first direction X1 side with respect to the broken line M.

The second outer electrode 20 includes a second outer electrode main body 21 arranged in the first direction X1 with respect to the base 30 and a second outer electrode extension 25 arranged in the first laminated direction Y1 with respect to the base 30. The second outer electrode main body 21 includes a second opposed wall 22 that is opposed to the second end surface 34 of the dielectric body 31 and an annular second joint 23 that projects from an edge portion of the second opposed wall 22 in the second direction X2. The second opposed wall 22 preferably has a plate shape and extends in the laminated direction and the width direction Z. The second opposed wall 22 preferably has a quadrangular shape when viewed in the length direction. The second inner electrodes 36 are joined to a surface in the second direction X2 of the second opposed wall 22.

The second joint 23 preferably has a rectangular or substantially rectangular frame shape when viewed in the length direction. An end portion in the first direction X1 of the base 30 is fitted into the second joint 23. A portion of the second joint 23 is arranged in the first laminated direction Y1 with respect to the dielectric body 31 to be abut against the first surface 32. A portion that is a portion of the second joint 23 and that abuts against the first surface 32 of the dielectric body 31 is hereinafter referred to as a second mounting surface sidewall 24.

The second outer electrode main body 21 is arranged in the second laminated direction Y2 with respect to the second land electrode 104. The second solder 112 is mainly joined to a face in the first direction X1 of the second opposed wall 22 (refer to FIG. 1). Accordingly, the second outer electrode 20 and the second land electrode 104 are electrically connected to each other.

The second outer electrode extension 25 extends from an edge portion of the second outer electrode main body 21 in the second direction X2. Here, the edge portion of the second outer electrode main body 21 is an edge portion of the second joint 23 (an end portion in the second direction X2 of the second mounting surface sidewall 24 in the present example embodiment). The second outer electrode extension 25 preferably has a plate shape and extends in the length direction and the width direction Z. The second outer electrode extension 25 is apart from the first surface 32 of the base 30 in the first laminated direction Y1. The insulating layer 40 exists between the second outer electrode extension 25 and the first surface 32.

An end portion 25a in the second direction X2 of the second outer electrode extension 25 is located on the second direction X2 side with respect to the broken line M. Accordingly, a portion of the first outer electrode extension 15 and a portion of the second outer electrode extension 25 are spaced apart from each other in the laminated direction and are opposed to each other in the orthogonal direction. Portions that are opposed to each other of the first outer electrode extension 15 and the second outer electrode extension 25 are hereinafter referred to as a pair of opposing portions 50, 50.

The insulating layer 40 exists between the pair of opposing portions 50, 50. The insulating layer 40 is also provided in the first laminated direction Y1 with respect to the first outer electrode extension 15. Accordingly, the surface in the first laminated direction Y1 of the first outer electrode extension 15 does not become exposed. In contrast, the insulating layer 40 is not provided in the first laminated direction Y1 with respect to the second outer electrode extension 25. Accordingly, the surface in the first laminated direction Y1 of the second outer electrode extension 25 becomes exposed. Next, the pair of opposing portions 50, 50 will be described in detail.

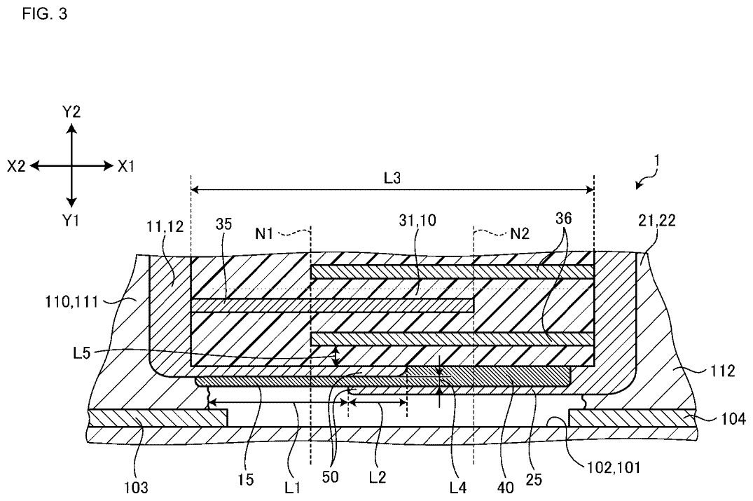

FIG. 3 is an enlarged view resulting from enlargement of a portion of FIG. 2. A virtual line N1 and a virtual line N2 in FIG. 3 are boundary lines when the base 30 is trisected in the length direction. More specifically, the virtual line N1 is a boundary line on the second direction X2 side with respect to the center in the length direction of the base 30 and the virtual line N2 is a boundary line on the first direction X1 side with respect to the center in the length direction of the base 30.

As illustrated in FIG. 3, the pair of opposing portions 50, 50 is arranged in the first laminated direction Y1 (the orthogonal direction) with respect to a central portion (a portion between the virtual line N1 and the virtual line N2) when the base 30 is trisected in the length direction. Accordingly, a distance L1 from the second outer electrode extension 25 to the first solder 111 is relatively long. Since the surface in the first laminated direction Y1 of the second outer electrode extension 25 becomes exposed, the surface may be joined to the first solder 111 eluted between the mounting surface 102 and the base 30. However, since the distance L1 is relatively long in the present example embodiment, the possibility of joining of the second outer electrode extension 25 and the first solder 111 is low.

A distance L2 in the length direction of the pair of the opposing portion 50, 50 is longer than or equal to about 1/20 of a length L3 in the length direction (the first direction X1) of the base 30, for example.

A distance L4 between the pair of opposing portions 50, 50 is longer than or equal to about 25 μm and is shorter than or equal to about 100 μm. If the distance L4 is longer than or equal to about 25 μm and is shorter than or equal to about 100 μm, the opposing portions 50, 50 are magnetically coupled to each other. Minute irregularities of about 10 μm or less may be provided on the surfaces of the opposing portions 50. If the distance L4 between the pair of opposing portions 50, 50 is at least about 25 μm even when protrusions of about 10 μm are provided on each of the pair of opposing portions 50, 50, the insulating layer 40 exists between the protrusions without fail. In other words, contact between the pair of opposing portions 50, 50 is avoided without fail. If the distance L4 between the pair of opposing portions 50, 50 exceeds about 100 μm, loss of a high-frequency signal may be undesirably increased.

A distance L5 between the first outer electrode extension 15 and the inner electrode (the second inner electrode 36 in FIG. 3) is longer than the distance L4 between the pair of opposing portions 50, 50. This reduces or prevents magnetic coupling between the first outer electrode extension 15 and the inner electrode (the second inner electrode 36 in FIG. 3).

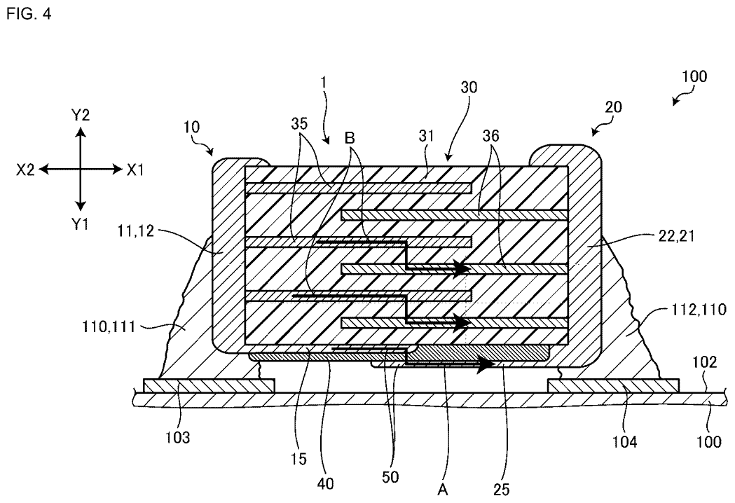

FIG. 4 is a diagram for describing the advantages of the electronic component of the first example embodiment. A case will now be described in which a signal is supplied from the first land electrode 103 to the first outer electrode 10 in the electronic component module 100 of the first example embodiment. As illustrated in FIG. 4, upon supply of the high-frequency signal from the first land electrode 103 to the first outer electrode 10, the high-frequency signal is supplied to the second outer electrode 20 through the pair of opposing portions 50, 50, which is a shortest path (refer to an arrow A in FIG. 4). The shortest path of the present example embodiment means the shortest circuit, among electric circuits connecting between the first land electrode 103 and the second land electrode 104. In other words, the pair of opposing portions 50, 50 is located on the mounting surface side, compared with the other inner electrodes, to be the shortest path. Accordingly, the high-frequency signal passes through the pair of opposing portions 50, 50 and does not pass through the dielectric layers between the first inner electrodes 35 and the second inner electrodes 36. This reduces or prevents the loss of the high-frequency signal.

A low-frequency signal passes through the first inner electrodes 35 and the second inner electrodes 36 (refer to arrows B in FIG. 4). Accordingly, according to the electronic component 1 of the present example embodiment, the direct-current electric components are removed and the loss of the signal is reduced or prevented over a wide band from the high-frequency band to the low-frequency band.

Although the electronic component 1 of the first example embodiment is described above, the present disclosure is not limited to this. For example, the positions in the length direction of the pair of opposing portions 50, 50 may be changed in the present disclosure. A first modification of an example embodiment of the present disclosure will now be described in which the positions in the length direction of the pair of opposing portions 50, 50 are changed.

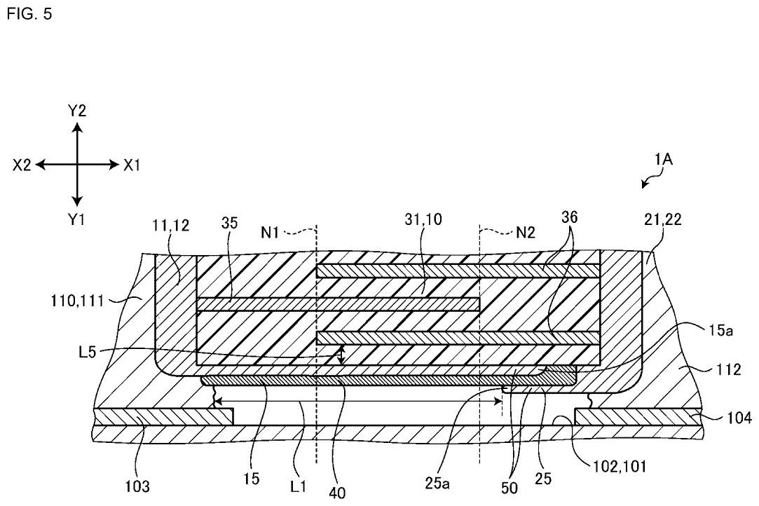

FIG. 5 is an enlarged view resulting from enlargement of an electronic component of the first modification. As illustrated in FIG. 5, an electronic component 1A of the first modification differs from the electronic component 1 of the first example embodiment in that the end portion 15a in the first direction X1 of the first outer electrode extension 15 is located on the first direction X1 side with respect to the virtual line N2. In addition, the electronic component 1A of the first modification differs from the electronic component 1 of the first example embodiment in that the end portion 25a in the second direction X2 of the second outer electrode extension 25 is located on the first direction X1 side with respect to the virtual line N2.

According to the first modification, a pair of opposing portions 50A, 50A is arranged in the first direction X1 (on the second outer electrode main body 21 side) with respect to the virtual line N2. Accordingly, the distance L1 between the first solder 111 and the second outer electrode extension 25 is longer than that in the first example embodiment. This makes the possibility of joining between the second outer electrode extension 25 and the first solder 111 very low.

Although the pair of opposing portions 50, 50 of the first example embodiment extends only in a portion at the outer periphery side of the base 30, the present disclosure is not limited to this. An example will be described in the second example embodiment in which the pair of opposing portions 50, 50 preferably has an annular shape. An example will be described in the second example embodiment in which an electronic component is provided in a coaxial cable, instead of the substrate 101.

### Second Example Embodiment

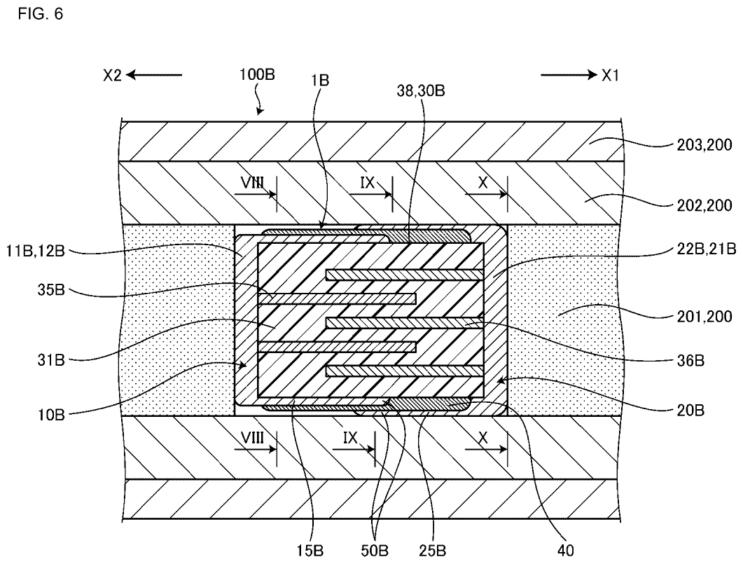

FIG. 6 is a cross-sectional view when an electronic component module of the second example embodiment is cut off along the center line of the coaxial cable. As illustrated in FIG. 6, an electronic component module 100B of the second example embodiment includes a coaxial cable 200 and an electronic component 1B. The coaxial cable 200 includes an inner conductor 201, a dielectric body 202, an outer conductor 203, and a protective layer (not illustrated), which are sequentially arranged from an inner periphery side. A portion of the inner conductor 201 is cut out to provide a space in which the electronic component 1B is provided. The electronic component 1B will be described, focusing on points different from the electronic component 1 of the first example embodiment.

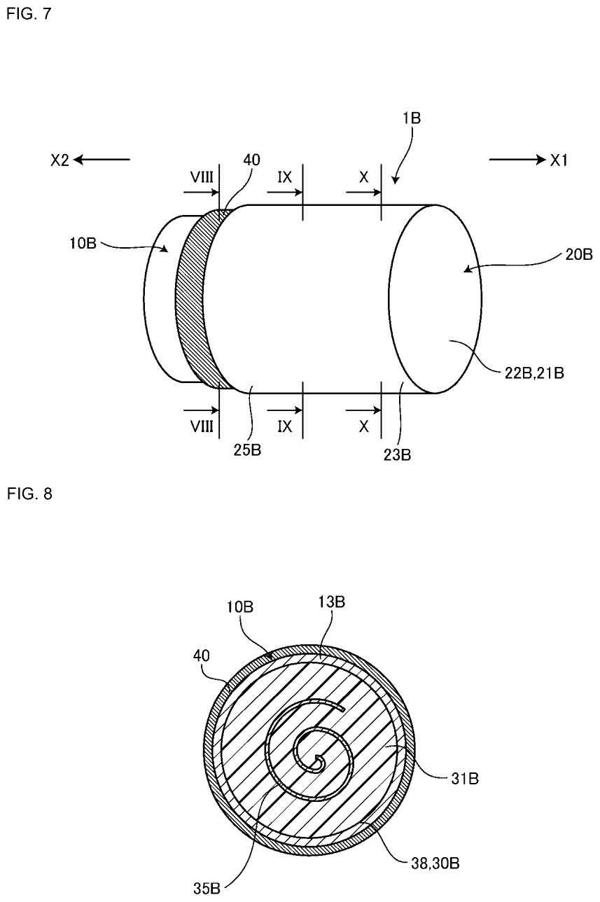

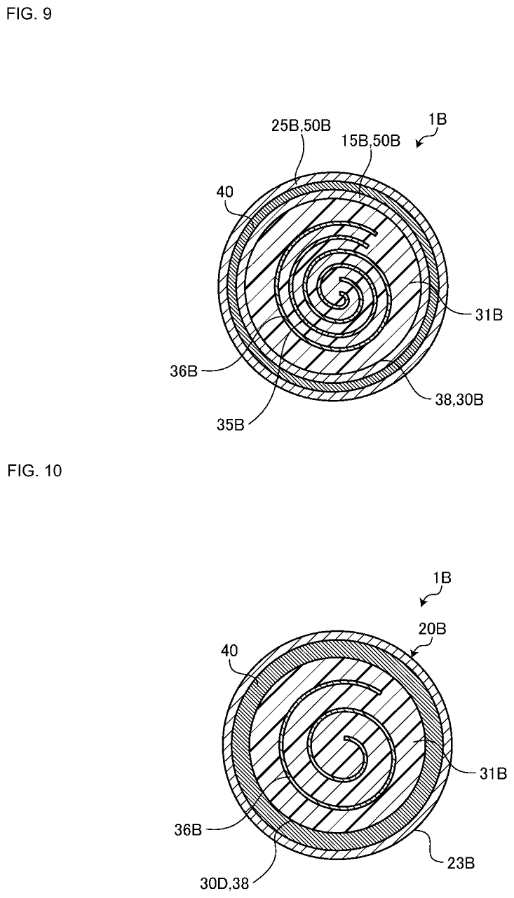

FIG. 7 is a perspective view of the electronic component of the second example embodiment. FIG. 8 is a cross-sectional view when a cross section taken along the VIII-VIII line in FIG. 7 is viewed from the direction of arrows. FIG. 9 is a cross-sectional view when a cross section taken along the IX-IX line in FIG. 7 is viewed from the direction of arrows. FIG. 10 is a cross-sectional view when a cross section taken along the X-X line in FIG. 7 is viewed from the direction of arrows.

As illustrated in FIG. 7, the electronic component 1B has the overall shape of a column. Accordingly, as illustrated in FIG. 8 to FIG. 10, the electronic component 1B has a circular cross-sectional shape in the orthogonal direction. An outer peripheral surface 38 of a base 30B also has a circular shape.

The base 30B is formed preferably by winding a multilayer body in which a dielectric sheet, a first inner electrode 35B, a dielectric sheet, and a second inner electrode 36B are sequentially laminated. Accordingly, a dielectric body 31B of the base 30B includes the two dielectric sheets.

In a first outer electrode 10B, a first opposed wall 12B of a first outer electrode main body 11B preferably has a circular or substantially circular shape, although not particularly illustrated. As illustrated in FIG. 8, a first joint 13B preferably has a cylindrical shape. As illustrated in FIG. 9, a first outer electrode extension 15B extends in a circumferential direction along an edge portion of the first joint 13B (the first outer electrode main body 11B). In other words, the first outer electrode extension 15B preferably has a cylindrical shape (annular shape). The first outer electrode extension 15B abuts against the outer peripheral surface 38 of the base 30B.

In a second outer electrode 20B, a second opposed wall 22B of a second outer electrode main body 21B preferably has a circular shape, as illustrated in FIG. 7. As illustrated in FIG. 10, a second joint 23B preferably has a cylindrical shape. As illustrated in FIG. 9, a second outer electrode extension 25 extends in the circumferential direction along an edge portion of the second joint 23B (the second outer electrode main body 21B). Accordingly, the second outer electrode extension 25 preferably has a cylindrical shape (annular shape).

As illustrated in FIG. 9, the inner diameter of the second outer electrode extension 25 is greater than the outer diameter of the first outer electrode extension 15B. The insulating layer 40 exists between the outer peripheral surface 38 of the base 30B and the second outer electrode extension 25. In other words, the second outer electrode extension 25 does not abut against the outer peripheral surface 38 of the base 30B. As illustrated in FIG. 6, the first outer electrode extension 15B and the second outer electrode extension 25B include portions that are opposed to each other in the orthogonal direction. In other words, in the first outer electrode extension 15B and the second outer electrode extension 25B, the portions opposed to each other provide a pair of opposing portions 50B, 50B.

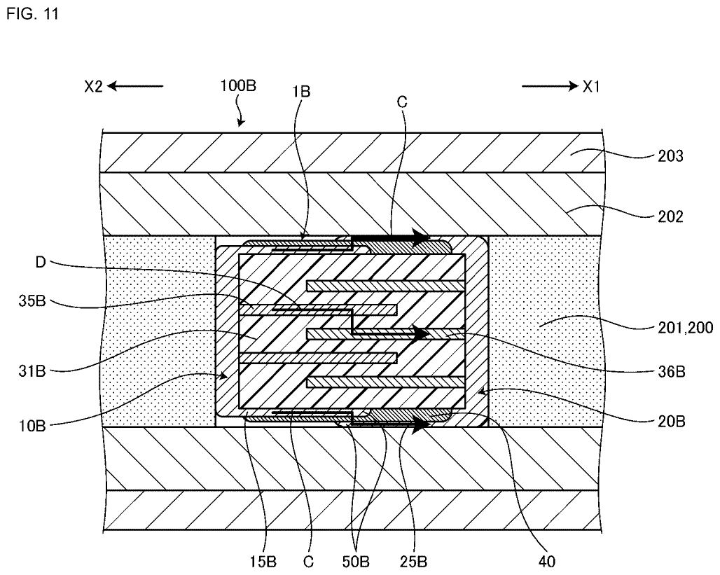

FIG. 11 is a diagram for describing the advantages of the electronic component of the second example embodiment. As illustrated in FIG. 11, according to the electronic component 1B of the second example embodiment, the high-frequency signal flows at the outer periphery side of the inner conductor 201 due to skin effect. Accordingly, upon supply of the high-frequency signal from the inner conductor 201 to the first outer electrode 10, the signal flows into the second outer electrode 20B through the pair of opposing portions 50B, 50B, which is at the outer periphery side of the electronic component 1B and which is the shortest path (refer to arrows C in FIG. 11). Accordingly, the high-frequency signal is not affected by the dielectric body 31B and the loss is reduced or prevented.

The pair of opposing portions 50B, 50B preferably has a cylindrical shape (annular shape). In other words, the path of the high-frequency signal is enlarged in the circumferential direction, compared with the case of the pair of opposing portions 50, 50 of the first example embodiment. Accordingly, according to the second example embodiment, the loss of the high-frequency signal is more reduced or prevented than the first example embodiment. The low-frequency signal passes at the inner periphery side of the inner conductor 201. Accordingly, upon supply of the low-frequency signal to the first outer electrode 10B, the low-frequency signal passes through the first inner electrode 35 and the second inner electrode 36 (refer to an arrow D in FIG. 11). As described above, also with the electronic component 1B of the second example embodiment, the loss of the signal is reduced or prevented over a wide band from the high-frequency band to the low-frequency band.

The second example embodiment is described above. A second modification resulting from modification of the second example embodiment will now be described.

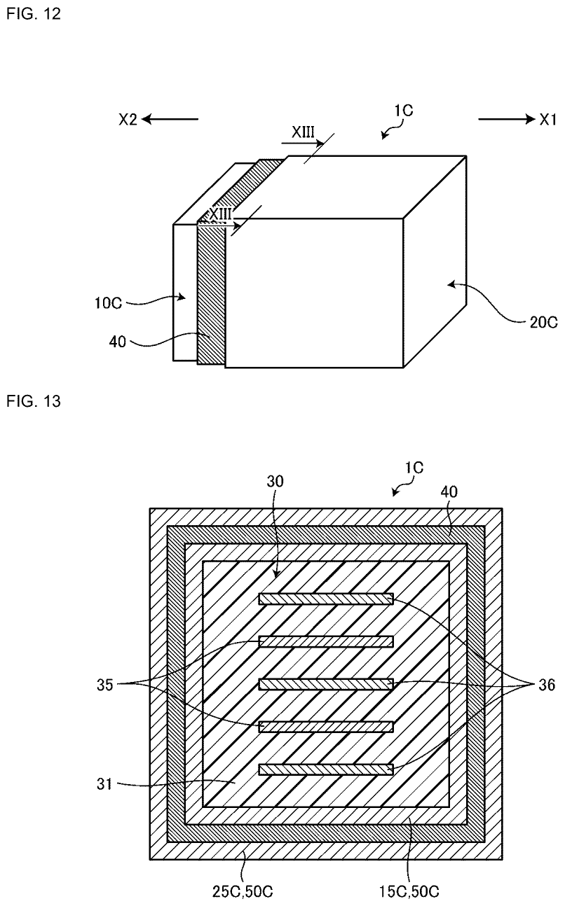

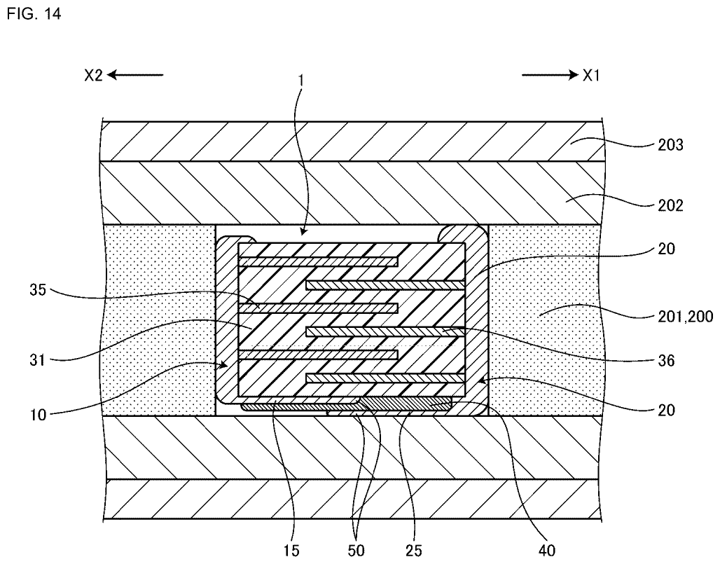

FIG. 12 is a diagram for describing the advantages of an electronic component of the second modification. FIG. 13 is a cross-sectional view when a cross section taken along the XII-XII line in FIG. 12 is viewed from the direction of arrows. As illustrated in FIG. 12, an electronic component 1C of the second modification preferably has a quadrangular prism shape. The cross-sectional shape of the electronic component 1C in the orthogonal direction is a quadrangular shape, as illustrated in FIG. 13.

A first outer electrode extension 15C of a first outer electrode 10C preferably having a quadrangular frame shape surrounding the outer periphery side of a base 30C. The insulating layer 40 located at the outer periphery side of the first outer electrode extension 15C also preferably has a quadrangular frame shape. In addition, a second outer electrode extension 25C of a second outer electrode 20C, which is located at the outer periphery side of the insulating layer 40, preferably also has a quadrangular frame shape.

According to the electronic component 1C of the second modification, a pair of opposing portions 50C, 50C preferably has a quadrangular frame shape (annular shape). Accordingly, the pair of opposing portions 50C, 50C is enlarged in the circumferential direction, compared with the pair of opposing portions 50, 50 of the first example embodiment. Consequently, the loss of the high-frequency signal is more reduced or prevented than the first example embodiment.

FIG. 14 is a cross-sectional view illustrating an example in which the electronic component of the first example embodiment is provided in the coaxial cable. Although the example is described in the first example embodiment in which the electronic component 1 is mounted on the substrate 101, the electronic component 1 may be provided in the coaxial cable 200, as illustrated in FIG. 14. The target on/in which the electronic component of the present disclosure is provided is not limited to the substrate and the coaxial cable. Although the overall shape of the electronic component is a hexahedron in which the ridges and the corners are chamfered in the first example embodiment and is a column in the second modification, the present disclosure may be embodied by, for example, an electronic component preferably with a rectangular parallelepiped (quadrangular prism shape).

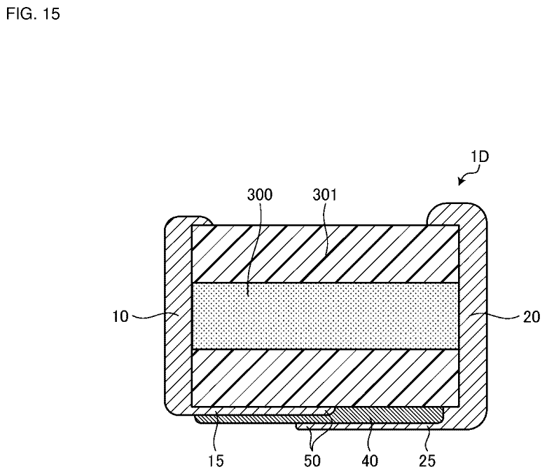

FIG. 15 is a cross-sectional view of an electronic component of a third modification. Although the base of each example embodiment and the base of each modification are capacitors each including the dielectric body and the inner electrodes, the base of the present disclosure may include a resistive body 300 and an insulating layer 301 insulating the periphery of the resistive body 300, as illustrated in FIG. 15. In other words, an electronic component 1D may provide a resistor. According to the electronic component 1D, when direct current flows through the first outer electrode 10, the low-frequency components in the direct current flow into the second outer electrode 20 through the resistive body 300. The high-frequency components in the direct current flow into the second outer electrode 20 through a pair of opposing portions 50D, 50D. Accordingly, the loss of the high-frequency signal is reduced or prevented. The base may be an inductor including a coil.

### Third Example Embodiment

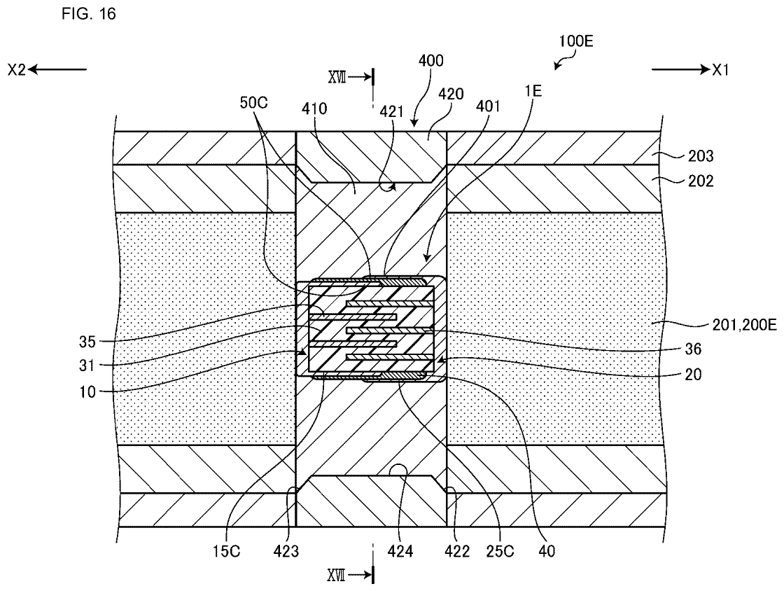

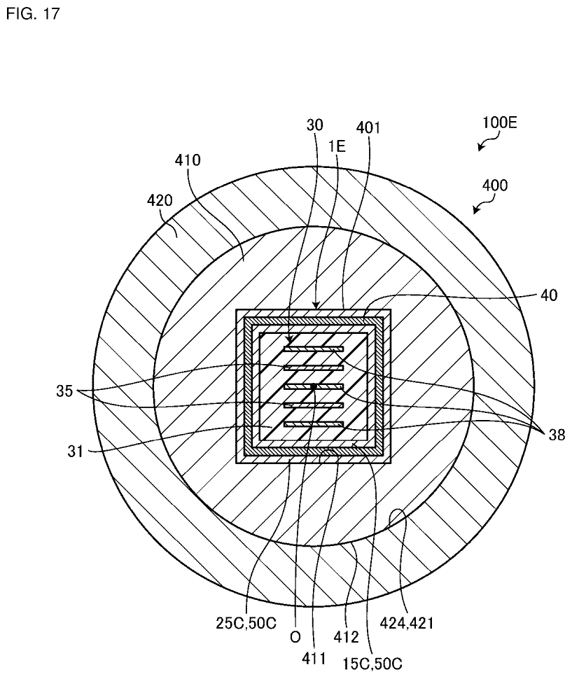

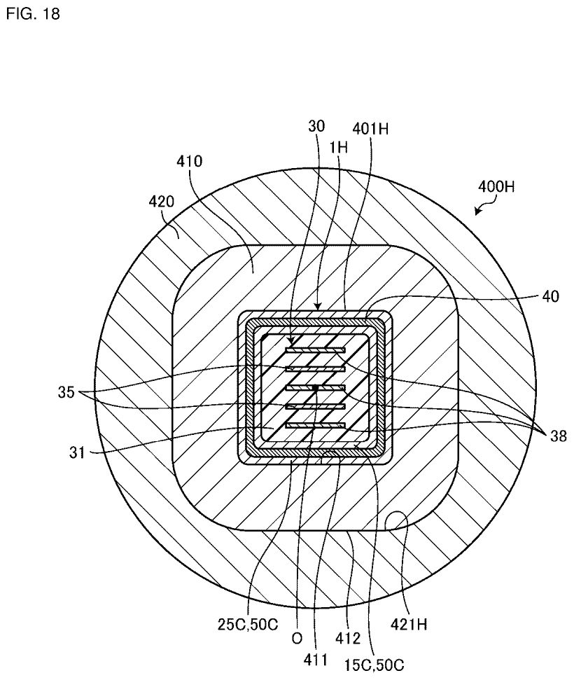

FIG. 16 is a cross-sectional view when an electronic component module of a third example embodiment is cut off along the center line of the coaxial cable. FIG. 17 is a cross-sectional view when a cross section taken along the XVII-XVII line in FIG. 16 is viewed from the direction of arrows. As illustrated in FIG. 16, an electronic component module 100E of the third example embodiment includes a coaxial cable 200E and a composite electronic component 400.

In the coaxial cable 200E of the third example embodiment, a portion of each of the inner conductor 201, the dielectric body 202, and the outer conductor 203 is cut out to provide a space in which the composite electronic component 400 is provided. Accordingly, the coaxial cable 200E of the third example embodiment differs from the coaxial cable 200 of the second example embodiment (refer to FIG. 6) in which only the inner conductor 201 is cut out.

The composite electronic component 400 is located (mounted) in the cut-out space in the coaxial cable 200E. The outer periphery side of the composite electronic component 400 is coated by a protective layer (not illustrated) of the coaxial cable 200. The composite electronic component 400 includes an electronic component 1E joined to the inner conductor 201, a holder portion 410 joined to the dielectric body 202, and an outer conductor portion 420 joined to the outer conductor 203.

As illustrated in FIG. 17, the outer peripheral surface of the composite electronic component 400 has a circular shape. In other words, the composite electronic component 400 is a column-shaped component. The center of the column including the composite electronic component 400 is hereinafter referred to as a center O of the composite electronic component 400. The electronic component 1E is arranged in a central portion of the composite electronic component 400. In other words, the electronic component 1E is arranged with no shift in a radial direction (the orthogonal direction) from the center O of the composite electronic component 400.

The electronic component 1E has a quadrangular shape viewed from the length direction. In other words, the electronic component 1E of the third example embodiment has the same structure as that of the electronic component 1C of the second modification, which preferably has the quadrangular prism shape. Accordingly, description of the electronic component 1E is omitted. The same reference numerals as those of the electronic component 1C are used in the drawings. As illustrated in FIG. 16, the diameter of an outer peripheral surface 401 of the electronic component 1E of the present example embodiment is smaller than the outer diameter of the inner conductor 201 of the coaxial cable 200E.

The holder portion 410 is made of dielectric. As illustrated in FIG. 17, the holder portion 410 extends in the circumferential direction along the outer peripheral surface 401 of the electronic component 1E so as to have an annular shape. The cross-sectional shape of an inner peripheral surface 411 of the holder portion 410 is a quadrangle in response to the outer peripheral surface 401 of the electronic component 1E. The inner peripheral surface 411 of the holder portion 410 is joined to the outer peripheral surface 401 of the electronic component 1E. The cross-sectional shape of an outer peripheral surface 412 of the holder portion 410 is a circle.

The outer conductor portion 420 is made of a conductive material. As illustrated in FIG. 17, the outer conductor portion 420 extends in the circumferential direction along the outer peripheral surface 412 of the holder portion 410 to preferably have an annular shape. The cross-sectional shape of an inner peripheral surface 421 of the outer conductor portion 420 is a circle in response to the outer peripheral surface 412 of the holder portion 410. The inner peripheral surface 421 of the outer conductor portion 420 is joined to the outer peripheral surface 412 of the holder portion 410.

As illustrated in FIG. 16, the inner peripheral surface 421 of the outer conductor portion 420 includes a first edge portion 422, a second edge portion 423, and an intermediate portion 424. The first edge portion 422 is an annular portion that is positioned at an end portion in the first direction X1 of the inner peripheral surface 421 of the outer conductor portion 420. The second edge portion 423 is an annular portion that is positioned at an end portion in the second direction X2 of the inner peripheral surface 421 of the outer conductor portion 420. The intermediate portion 424 is an annular portion that is positioned between the first edge portion 422 and the second edge portion 423 of the inner peripheral surface 421 of the outer conductor portion 420.

The distance (the thickness in the radial direction of the holder portion 410) between the inner peripheral surface 421 (the intermediate portion 424) of the outer conductor portion 420 and the outer peripheral surface 401 of the electronic component 1E is a distance (thickness) having a desired impedance value. Here, the desired impedance value is the impedance value between the inner conductor 201 and the outer conductor 203 of the coaxial cable 200E. Accordingly, in the present example embodiment, impedance matching is achieved between the coaxial cable 200E and the composite electronic component 400.

The first edge portion 422 and the second edge portion 423 each include a tapered shape. More specifically, the diameter of the first edge portion 422 is increased toward the first direction X1. The diameter of the second edge portion 423 is increased toward the second direction X2. The diameter at an edge in the first direction X1 of the first edge portion 422 and the diameter at an edge in the second direction X2 of the second edge portion 423 are the same as the diameter of the inner peripheral surface of the outer conductor 203 of the coaxial cable 200E. Accordingly, the inner peripheral surface 421 of the outer conductor portion 420 has a convex shape in which the intermediate portion 424 is convex shaped toward the electronic component 1E.

The advantages of the third example embodiment will now be described. Only the electronic component 1B is mounted in the coaxial cable 200 in the electronic component module 100B of the second example embodiment described above. In the case of such a structure, the electronic component 1B may be shifted from the center of the inner conductor 201 in the radial direction. As a result, the distance between the outer peripheral surface of the electronic component 1B and the outer conductor 203 of the coaxial cable 200, that is, the thickness of the dielectric body 202 may be varied depending on the position in the circumferential direction. In other words, the impedance between the outer peripheral surface of the electronic component 1B and the outer conductor 203 does not necessarily have a desired value. In contrast, the composite electronic component 400 of the third example embodiment includes not only the electronic component 1E but also the holder portion 410 and the outer conductor portion 420. In other words, the distance between the electronic component 1E and the outer conductor portion 420 is not varied depending on the position in the circumferential direction. Accordingly, the bandpass characteristics of the high-frequency signal is improved, compared with the second example embodiment.

When the first edge portion 422 and the second edge portion 423 do not have the tapered shapes, that is, when the entire inner peripheral surface 421 of the outer conductor portion 420 has the same diameter as that of the intermediate portion 424, a stepped surface that protrudes from the inner peripheral surface of the outer conductor 203 toward the inner side in the radial direction and that extends in the orthogonal direction is located between the outer conductor portion 420 and the outer conductor 203 of the coaxial cable 200E. The formation of the stepped surface causes the high-frequency signal to be likely to be reflected. In contrast, according to the third example embodiment, since the composite electronic component 400 has the first edge portion 422 and the second edge portion 423 that have the tapered shapes, the stepped surface extending in the orthogonal direction is not provided to reduce or prevent the reflection of the high-frequency signal.

The composite electronic component 400 of the third example embodiment is described above. Modifications resulting from modification of a portion of the composite electronic component 400 of the third example embodiment will now be described.

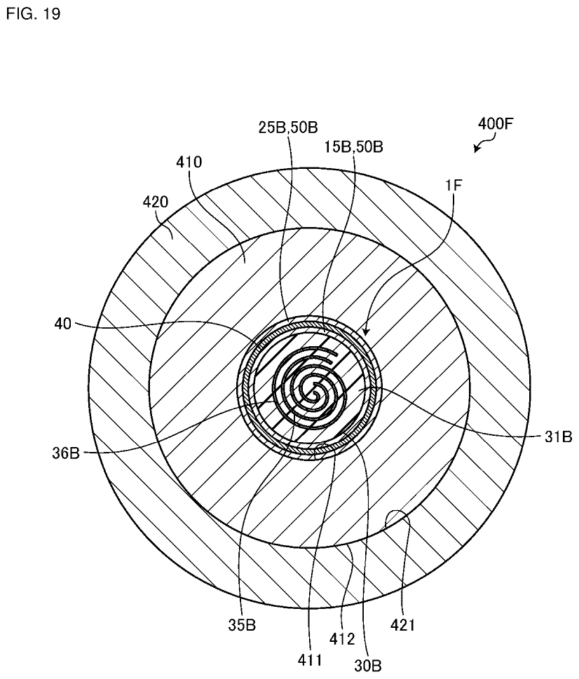

FIG. 18 is a cross-sectional view when a composite electronic component of a fourth modification is cut off in the orthogonal direction. As illustrated in FIG. 18, the fourth modification is common to the third example embodiment in that an electronic component 1H in a composite electronic component 400H of the fourth modification has a quadrangular prism shape. The fourth modification differs from the third example embodiment in that the corners of the electronic component 1H are chamfered. Specifically, an outer peripheral surface 401H of the electronic component 1H has a quadrangular shape when viewed from the length direction and has arc shaped corners. The fourth modification differs from the third example embodiment in that an inner peripheral surface 421H of the composite electronic component 400H of the fourth modification has a quadrangular shape when viewed from the length direction and has arc shaped corners. In other words, in the fourth modification, the inner peripheral surface 421H of an outer conductor portion 420H has a shape similar to that of the outer peripheral surface 401H of the electronic component 1H (similar shape). The composite electronic component 400H has the same advantages as those of the third example embodiment. In addition, the distance between the outer peripheral surface 401H of the electronic component 1H and the inner peripheral surface 421H of the outer conductor portion 420H is uniform and, thus, it is possible to avoid concentration of current distribution. Accordingly, loss of power is reduced or prevented, compared with the third example embodiment. The inner peripheral surface of the outer conductor portion of the present disclosure is not limited to the examples in the third example embodiment and the fourth modification and may have a circular shape or another shape.

FIG. 19 is a cross-sectional view when a composite electronic component of a fifth modification is cut off in the orthogonal direction. As illustrated in FIG. 19, the fifth modification differs from the third example embodiment in that a composite electronic component 400F of the fifth modification includes a column-shaped electronic component 1F, instead of the quadrangular-prism-shaped electronic component 1E. The electronic component 1F has the same structure as that of the electronic component 1B described in the second example embodiment. Accordingly, description of the electronic component 1F is omitted. The same reference numerals as those of the electronic component 1B are used in the drawings. Also with the composite electronic component 400F, it is possible to achieve the same advantages as those in the third example embodiment.

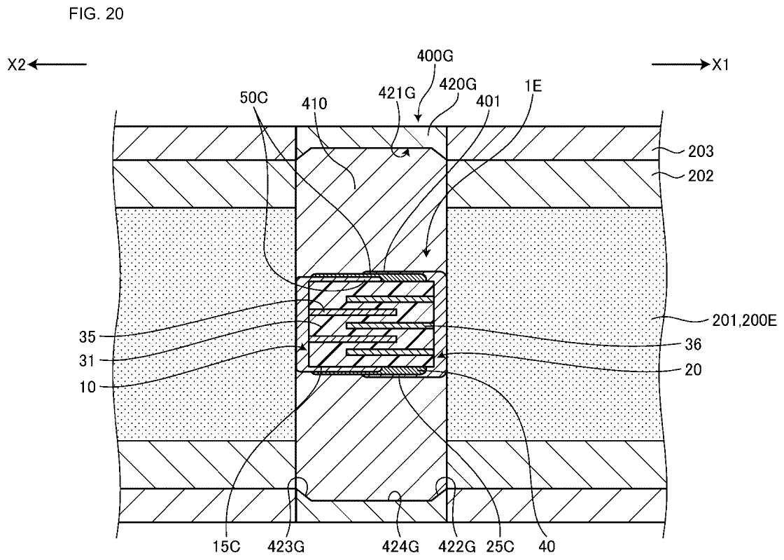

FIG. 20 is a cross-sectional view when an electronic component module of a sixth modification is cut off along the center line of the coaxial cable. As illustrated in FIG. 20, a composite electronic component 400G of the sixth modification differs from the composite electronic component 400 of the third example embodiment in the shape of an inner peripheral surface 421G of an outer conductor portion 420G. The composite electronic component 400G of the sixth modification will now be described in detail.

The distance between an intermediate portion 424G of the outer conductor portion 420G and the outer peripheral surface 401 of the electronic component 1E is greater than the diameter of the inner peripheral surface of the outer conductor 203 of the coaxial cable 200E in order to achieve a desired impedance value. The diameter of a first edge portion 422G is decreased toward the first direction X1. The diameter of a second edge portion 423G is decreased toward the second direction X2. Accordingly, an inner peripheral surface 421G of the outer conductor portion 420G has a concave shape in which the intermediate portion 424G is concave shaped toward the outer periphery side of the outer conductor portion 420G.

Since the first edge portion 422F and the second edge portion 423F have tapered shapes also in the sixth modification, the reflection of the high-frequency signal is reduced or prevented.

Although the modifications of the composite electronic component 400 are described above, the first edge portion 422 and the second edge portion 423 of the outer conductor portion 420 do not necessarily have the tapered shapes in the present disclosure.

Non-limiting examples will now be described. In the examples, S11 (reflection characteristics) and S21 (transmission characteristics) of scattering(S) parameters when the electronic component was provided in the coaxial cable (refer to FIG. 11) and the high-frequency signals were supplied were calculated. The high-frequency signals have two kinds of frequencies: a frequency of about 20 GHZ and a frequency of about 100 GHz, for example.

The electronic components according to the examples is the electronic component 1C of the quadrangular prism shape (rectangular parallelepiped) described in the second modification (refer to FIG. 12), which includes the pair of opposing portions 50D, 50D of a quadrangular frame shape (refer to FIG. 13). Three electronic components were prepared and the distance L4 (refer to FIG. 3) between the pair of opposing portions 50D, 50D in each of the electronic components was varied. In a first electronic component (hereinafter referred to as a first example), the distance L4 between the pair of opposing portions 50D, 50D is about 25 μm, for example. In a second electronic component (hereinafter referred to as a second example), the distance L4 between the pair of opposing portions 50D, 50D is about 50 μm, for example. In a third electronic component (hereinafter referred to as a third example), the distance L4 between the pair of opposing portions 50D, 50D is about 100 μm, for example.

In order to confirm the advantages of the examples, an electronic component of a comparative example was prepared. The electronic component of the comparative example is an electronic component in which the first outer electrode extension 15C and the second outer electrode extension 25C are removed from the electronic component on the quadrangular prism side described in the second modification. In other words, the electronic component of the comparative example does not include the pair of opposing portions 50, 50 of the quadrangular frame shape.

First, S11 (reflection characteristics) of the S parameters of each example embodiment and the comparative example is indicated in Table 1:

TABLE 1

| FREQUENCY OF SIGNAL | 20 GHz | | 100 GHz |
|---|---|---|---|
| FIRST EXAMPLE (25 μm) | −15.1 | dB | −8 dB |
| SECOND EXAMPLE (50 μm) | −14.8 | dB | −5 dB |
| THIRD EXAMPLE (100 μm) | −15 | dB | −4 dB |
| COMPARATIVE EXAMPLE | −10 | dB | −4 dB |

S11 (reflection characteristics) of the S parameters of smaller values indicates that the high-frequency signals of lager amounts pass through the electronic component. When the frequency of the signal is 20 GHZ, S11 (reflection characteristics) of all of the first example to the third example yielded more excellent results than the comparative example, as indicated in Table 1. When the frequency of the signal is 100 GHZ, S11 (reflection characteristics) of the first example and the second example yielded more excellent results than the comparative example. Accordingly, according to the examples, the reflection of the high-frequency signal was Next, reduced. S21 (transmission characteristics) of the S parameters of each example embodiment and the comparative example is indicated in Table 2:

TABLE 2

| FREQUENCY OF SIGNAL | 20 GHz | | 100 GHz |
|---|---|---|---|
| FIRST EXAMPLE (25 μm) | −0.13 | dB | −1.9 dB |
| SECOND EXAMPLE (50 μm) | −0.15 | dB | −2.1 dB |
| THIRD EXAMPLE (100 μm) | −0.19 | dB | −2.5 dB |
| COMPARATIVE EXAMPLE | −0.5 | dB | −3.8 dB |

S21 (transmission characteristics) of the S parameters of values closer to 0.1 indicates that the loss of the signal is made smaller. In both the case in which the frequency of the signal is 20 GHz and the case in which the frequency of the signal is 100 GHz, S21 (transmission characteristics) of the first example to the third example yielded more excellent results than the comparative example, as indicated in Table 2. In other words, according to the examples, the loss of the high-frequency signal was reduced or prevented.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic component comprising:
a first outer electrode;
a base; and
a second outer electrode; wherein
the first outer electrode, the base, and the second outer electrode are sequentially arranged in a first direction;
a direction opposite to the first direction is a second direction;
a direction orthogonal to the first direction is an orthogonal direction;
the first outer electrode includes:
a first outer electrode main body arranged in the second direction with respect to the second outer electrode over the base; and
a first outer electrode extension that extends in the first direction from an edge portion of the first outer electrode main body;
the second outer electrode includes:
a second outer electrode main body arranged in the first direction with respect to the first outer electrode over the base; and
a second outer electrode extension that extends in the second direction from an edge portion of the second outer electrode main body;
a portion of the first outer electrode extension and a portion of the second outer electrode extension define a pair of opposing portions that are opposed to each other in the orthogonal direction; and
an insulating layer is provided between the pair of opposing portions.

2. The electronic component according to claim 1, wherein a cross section of electronic component in the orthogonal direction has a rectangular or substantially rectangular shape and an entire shape is a rectangular or substantially rectangular parallelepiped.

3. The electronic component according to claim 1, wherein an entire shape of the electronic component is a hexahedron and at least one of ridges and corners of the hexahedron is chamfered.

4. The electronic component according to claim 1, wherein a cross section in the orthogonal direction has a circular or substantially circular shape and an entire shape is a column.

5. The electronic component according to claim 1, wherein an outer peripheral surface of the base includes a first surface opposed to a substrate on which the electronic component is mounted;
the first outer electrode extension and the second outer electrode extension are located on the first surface side with respect to the base; and
the pair of opposing portions is located in the orthogonal direction with respect to a central portion when the base is trisected in the first direction.

6. The electronic component according to claim 1, wherein
an outer peripheral surface of the base includes a first surface opposed to a substrate on which the electronic component is mounted;
the first outer electrode extension and the second outer electrode extension are located on the first surface side with respect to the base;
the first outer electrode extension is located on the base side with respect to the second outer electrode extension; and
the pair of opposing portions is located on the second outer electrode main body side with respect to a central portion when the base is trisected in the first direction.

7. The electronic component according to claim 1, wherein
on a cross section in the orthogonal direction, the first outer electrode extension extends in a circumferential direction along an edge portion of the first outer electrode main body with an annular shape;
the second outer electrode extension extends in the circumferential direction along an edge portion of the second outer electrode main body with an annular shape; and
each opposing portion in the pair of opposing portions has an annular shape.

8. The electronic component according to claim 1, wherein a length in the first direction of the pair of opposing portions is longer than or equal to about 1/20 of a length in the first direction of the base.

9. The electronic component according to claim 1, wherein the base includes a plurality of inner electrodes to provide a capacitor.

10. The electronic component according to claim 1, wherein the base includes a resistive body to provide a resistor.

11. The electronic component according to claim 1, wherein a distance between the pair of opposing portions is longer than or equal to about 25 μm and shorter than or equal to about 100 μm.

12. The electronic component according to claim 1, wherein the pair of opposing portions is magnetically coupled to each other.

13. A composite electronic component comprising:
the electronic component according to claim 7;
an annular holder portion that extends in a circumferential direction along an outer peripheral surface of the electronic component; and
an annular outer conductor portion that extends in the circumferential direction along an outer peripheral surface of the holder portion.

14. The composite electronic component according to claim 13, wherein an inner peripheral surface of the outer conductor portion includes:
an annular first edge portion that is positioned at an end portion in the first direction of the inner peripheral surface of the outer conductor portion,
an annular second edge portion that is positioned at an end portion in the second direction of the inner peripheral surface of the outer conductor portion; and
an annular intermediate portion that is positioned between the first edge portion and the second edge portion of the inner peripheral surface of the outer conductor portion; and
the first edge portion and the second edge portion each include a tapered shape.

15. The composite electronic component according to claim 14, wherein
a diameter of the first edge portion is increased toward the first direction;
a diameter of the second edge portion is increased toward the second direction; and
the inner peripheral surface of the outer conductor portion has a convex shape in which the intermediate portion is convex shaped toward the electronic component.

16. The composite electronic component according to claim 14, wherein
a diameter of the first edge portion is decreased toward the first direction;
a diameter of the second edge portion is decreased toward the second direction; and
the inner peripheral surface of the outer conductor portion has a concave shape in which the intermediate portion is concave shaped toward an outer periphery side of the electronic component.

17. A coaxial cable including the electronic component according to claim 1.

18. The electronic component according to claim 1, wherein the base includes an inductor.

19. An electronic component module comprising the composite electronic component of claim 13 and a coaxial cable.

20. The electronic component module according to claim 19, wherein the composite electronic component is located in a cut-out space in the coaxial cable.
